(19) United States
(12) Patent Application Publication
(10) Pub. No.: US 2005/0135644 A1
(43) Pub. Date: Jun. 23, 2005

(54) Digital cell phone with hearing aid functionality

(76) Inventor: Yingyong Qi, San Diego, CA (US)

Correspondence Address: MORRISON & FOERSTER LLP, 3811 VALLEY CENTRE DRIVE, SUITE 500, SAN DIEGO, CA, 92130-2332, US

(21) Appl. No.: 10/967,966

(22) Filed: Oct. 19, 2004

Related U.S. Application Data
(60) Provisional application No. 60/532,736, filed on Dec. 23, 2003.

(51) Int. Cl. H04R 25/00

(52) U.S. Cl. 381/314; 381/312

(57) ABSTRACT

A digital cell phone with built in hearing aid functionality, includes: a housing; a digital signal processor (DSP) contained within the housing for encoding and decoding digital data; a hearing loss compensation module, coupled to the DSP, for processing digital data in accordance with a hearing loss compensation algorithm; a digital-to-analog converter (DAC), coupled to the hearing loss compensation module, for receiving the processed digital data from the hearing loss compensation circuit and converting the data into an analog signal; and a speaker, coupled to the DAC, for receiving the analog signal and converting the analog signal into sound waves adapted for a hearing impaired listener.

### RELATED APPLICATIONS

The present application claims the benefit of priority under 35 U.S.C. § 119(e) to U.S. Provisional Patent Application Ser. No. 60/532,736 entitled “METHOD AND SYSTEM FOR ENABLING HEARING AID FUNCTIONS VIA A DIGITAL CELL PHONE,” filed on Dec. 23, 2003, the entirety of which is incorporated by reference herein.

### BACKGROUND OF THE INVENTION

In the last decade, hearing aid technology has advanced rapidly due to the development and availability of digital hearing aids. One significant advantage of digital hearing aids is their ability to be precisely controlled by software. Many digital signal processing (DSP) programs, such as multi-channel compression, adaptive noise reduction, and speech enhancement, can be implemented in digital hearing aids. These DSP programs provide potential benefits to hearing-aid users that otherwise would be difficult to obtain on an analog device. Currently existing digital hearing aids, however, have significant physical limitations. Due to size constraints and cost considerations, digital hearing aids do not have an adequate amount of computing resources, such as processor speed, memory space, and power supply capacity, for advanced signal processing functionality. Hearing aids capable of storing and executing multiple programs, for example, would permit users to switch from one program to another to meet their needs in a variety of listening environments. However, this multi-program functionality is currently difficult to achieve due to the physical limitations of digital hearing aids.

Advancements in wireless communications have paralleled the advancements in hearing aid technology. Digital cell phones have become indispensable tools that enable people to communicate wirelessly around the nation or the world wherever wireless service is available. The acoustic characteristics of a cell phone, however, are designed for users with normal hearing. Therefore, people with sensory hearing loss must still wear hearing aids to properly use a cell phone. It is inefficient and cumbersome to require a user to use two (digital) devices to make a simple wireless call. In addition, many digital wireless phones can emit electromagnetic energy that interferes with hearing aids, turning amplified sounds into static noise and squeals.

### BRIEF SUMMARY OF THE INVENTION

The invention addresses the above and other problems by providing a method and system for enabling hearing aid functions on digital cell phones so that a hearing impaired person can use the phone without the need for a separate hearing aid.

In one embodiment, the processing power of a digital cell phone is utilized to implement advanced signal processing algorithms or functions that are difficult to implement on resource-limited digital hearing aids.

In further embodiments, the user interface and wireless download capabilities of digital cell phones provide flexibility to the control and implementation of hearing-aid functions.

In one embodiment, the invention provides a digital cell phone having hearing aid functionality, the cell phone including: a microprocessor; a memory, coupled to the microprocessor, for storing at least one program executable by the microprocessor; a key pad, coupled to the microprocessor, for entering alphanumeric information to be processed by the microprocessor; a display screen, coupled to the microprocessor, for displaying alphanumeric information received from the microprocessor; a radio frequency (RF) antenna, coupled to the microprocessor, for transmitting and receiving RF signals; a microphone for receiving sound waves and converting the sound waves into an analog signal; an analog-to-digital converter (ADC), coupled to the microphone, for converting the analog signal received from the microphone into a digital data format; a digital signal processor (DSP) comprising an encoder for encoding digital data into an RF signal format to be transmitted by the RF antenna and a decoder for decoding digital data received by the RF antenna; a hearing loss compensation module, coupled to the DSP, for processing digital data in accordance with a hearing loss compensation algorithm; a digital-to-analog converter (DAC), coupled to the hearing loss compensation module, for converting the processed digital data received from the hearing loss compensation module into an analog signal; and a speaker, coupled to the DAC, for receiving the analog signal from the DAC and outputting audible sound waves adapted for listening by a hearing impaired user.

In another embodiment, a hearing loss compensating communication system includes: a digital cell phone for transmitting and receiving voice data, wherein the digital cell phone comprises circuitry for converting sound waves into a digital data format for transmission and converting received voice data into audible sound waves; and a hearing loss compensation module, coupled to the circuitry, for further processing the received voice data in accordance with a hearing loss compensation algorithm, wherein the processed voice data when converted into an analog format provides enhanced sound waves adapted for listening by a hearing impaired listener.

In a further embodiment, a digital cell phone with built in hearing aid functionality, includes: a housing; a digital signal processor (DSP) contained within the housing for encoding and decoding digital data; a hearing loss compensation module, coupled to the DSP, for processing digital data in accordance with a hearing loss compensation algorithm; a digital-to-analog converter (DAC), coupled to the hearing loss compensation module, for receiving the processed digital data from the hearing loss compensation circuit and converting the data into an analog signal; and a speaker, coupled to the DAC, for receiving the analog signal and converting the analog signal into sound waves adapted for a hearing impaired listener.

In another embodiment, a method of compensating for hearing loss using a digital telephone, includes the following acts: receiving a digital signal via a digital phone; decoding the digital signal so as to provide a second digital signal in a predefined format; processing the second digital signal in accordance with a hearing loss compensation algorithm so as to provide a hearing loss compensated digital signal; converting the hearing loss compensated digital signal into an analog signal; and converting the analog signal into audible sound waves adapted for a hearing impaired listener.

### BRIEF DESCRIPTION OF THE FIGURES

FIG. 1 illustrates a block diagram of a conventional hearing aid.

FIG. 2 illustrates a block diagram of a hearing loss compensation circuit found in conventional hearing aids.

FIG. 3A illustrates a block diagram of a conventional digital cell phone.

FIG. 3B illustrates a block diagram of a typical DSP unit found in a conventional digital cell phone.

FIG. 4 illustrates a block diagram of an enhanced DSP unit having a hearing loss compensation module, in accordance with one embodiment of the invention.

FIG. 5 illustrates a block diagram of an exemplary hearing loss compensation module used in the enhanced DSP unit of FIG. 4, in accordance with one embodiment of the invention.

FIG. 6 illustrates a structural block diagram of a filter bank and a corresponding frequency response of the filter bank.

FIG. 7 illustrates an exemplary piece-wise linear gain function that may utilized by one or more filters/channels of the filter bank of FIG. 6, in accordance with one embodiment of the invention.

### DETAILED DESCRIPTION OF THE PREFERRED EMBODIMENTS

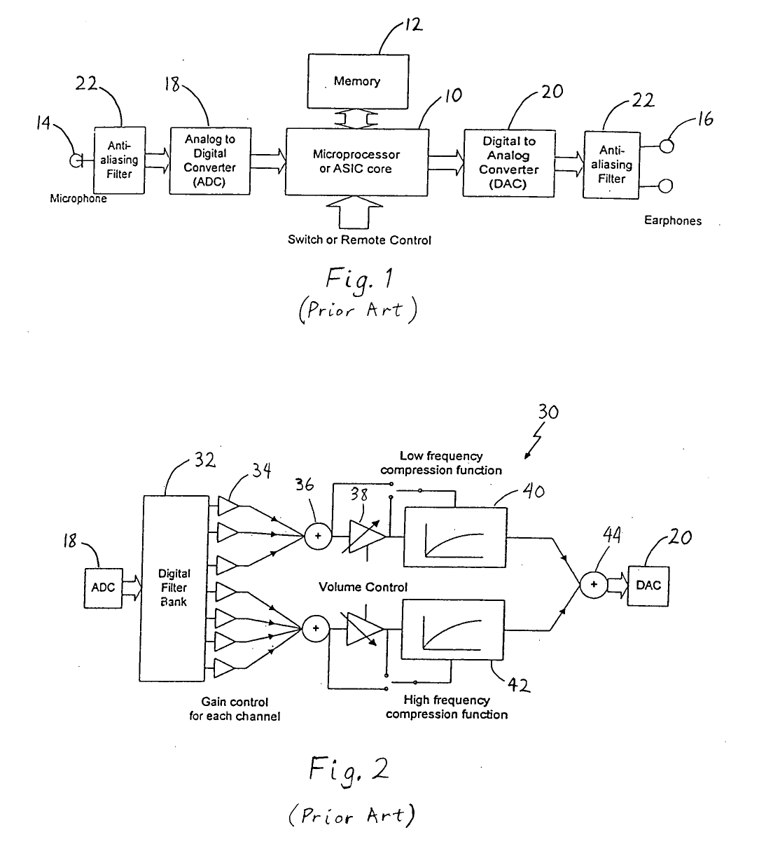

A block diagram of the general architecture of conventional digital hearing aids is illustrated in FIG. 1. Digital hearing aids typically include a microprocessor or ASIC core 10, a limited memory space 12 communicatively coupled to the microprocessor 10, a mini-microphone 14 and mini-speaker(s) or ear phone(s) 16, an analog to digital converter (ADC) 18 and a digital to analog converter (DAC) 20, and their associated anti-aliasing filters/circuits 22 for reducing distortion and signal degradation by the ADC and DAC circuits. Speech and other sound signals are gathered by the mini-microphone 14. The signal passes through the first anti-aliasing circuit 22 to band limit the signal and reduce distortion. The signal is then converted to digital form by the ADC 18. The resulting digital signal is processed by the microprocessor 10 based on one or more programs stored in the memory 12 and executed by the microprocessor 10. Thereafter, the enhanced digital signal is converted back to an analog signal by the DAC 20, filtered by the second anti-aliasing filter 22 and output by ear phone speakers 16. In conventional hearing aid devices, all of these components and a cell battery are packed into a small container or package so that the hearing aid can be worn inside or behind the ear. Such hearing aid devices and the above-described components and circuits are well known in the art.

An exemplary signal processing circuit 30 (or program if implemented in software) that is contained in (or executed by) the microprocessor or ASIC core 10 is illustrated in FIG. 2. Digital signals representative of analog sound (e.g., speech) are received from the ADC 18 and processed by a digital filter bank 32. The digital filter bank includes circuitry for performing, inter alia, the functions of splitting the received signals into different frequency bands. The different frequency bands are then provided to a plurality of amplifiers (e.g., gain control amplifiers or operational amplifiers) 34 for properly amplifying selected frequencies or frequency ranges received from the digital filter bank 32. The different frequency bands or channels are then combined together by signal summer circuits 36 and then provided to respective volume control circuits 38 and a low-frequency compression circuit 40 and a high-frequency compression circuit 42. The outputs of the compression circuits 40 and 42 are then summed by a summer circuit 44 and the processed signal is delivered to the listener through the DAC 20 and the earphones 16.

In some hearing aids, a simple switch or remote control is available to allow the user to choose the settings of the device from a small set of options and programs in order to best compensate a user's particular hearing loss characteristics and/or a few common environments that the hearing aids will most likely be used. These options and programs are initially adjusted and set by a certified audiologist on a computer-assisted platform. Two hearing aids are needed if both ears have hearing loss.

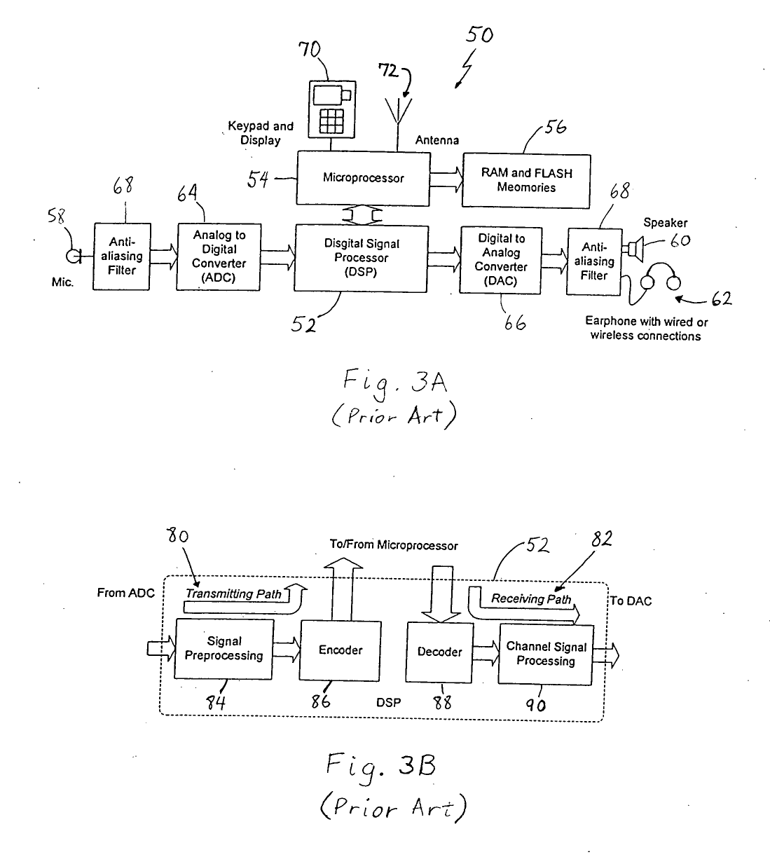

The general hardware structure of a digital cell phone 50 and a block diagram of some common audio signal processing components inside a digital signal processor (DSP) 52 contained in a digital cell phone 50 are shown in FIGS. 3A and 3B, respectively. As shown, the digital cell phone 50 has all the necessary hardware components to support the function of hearing aids. In fact, the digital cell phone is a far superior digital device than a hearing aid in terms of processor speed, memory space, user interface, and power supply capabilities.

As shown in FIG. 3A, the digital cell phone 50 typically has the following main components or features: a microprocessor 54 that controls the general functions of the cell phone 50 (e.g., answering incoming calls and making outgoing calls based on inputs received from a user, storing and looking up contact information, etc.); the DSP 52 that is designed for real-time execution of DSP programs such as signal encoding and decoding; a relatively large amount of RAM and/or FLASH memory 56 that supports not only the necessary phone operations, but also the down load and execution of optional programs such as ring tone composers, voice memo tools, etc; a microphone 58 for receiving audio sound (e.g., speech); a mini-speaker 60 and/or a stereo ear-phone outlet for providing signals to ear phones 62, and their associated ADC 64 and DAC 66 converters that convert between the analog speech or other acoustic signal and the digital signal; respective anti-aliasing filter circuits 68; a key pad and a display 70 that permits easy user control on the function of the device; and an radio frequency (RF) antenna 72 that receives and transmits RF signals.

The digital cell phone 50 further includes a long-lasting power supply (not shown) that can be recharged conveniently at home or on a vehicle. Many digital cell phones today further include wireless interfaces, circuitry and associated software that enable the cell phones to receive and transmit digital data via wireless communication networks (e.g., Verizon's wireless communication network), a wide area network such as the Internet, and via local electronic devices, such as Bluetooth headphones. As is well known in the art, Bluetooth is a short range RF communication protocol.

Usually, the DSP 52 is responsible for audio signal processing as shown in FIG. 3B. Speech signals have two major paths inside the DSP: a transmitting path 80 and a receiving path 82. In the transmitting path 80, speech from a user is received by the mini-microphone 58. It is then pre-filtered and converted into a digital signal by filter 68 and ADC 64, respectively. The resulting digital signal is then further processed by a signal preprocessing circuit 84 (e.g., pre-conditioning to remove noise, balance frequencies, etc. for more efficient encoding) and encoded into bit streams by an encoder 86 before the bit streams are sent to the microprocessor 54 for transmission via the RF antenna 72.

In the receiving path 82, a digital bit-stream from a base station (not shown), for example, is received by the antenna 72, processed by the microprocessor 54 (e.g., remove header and/or overhead information, etc.) and then sent to the DSP 52. A decoder 88 contained within the DSP 52 first decodes the digital bit-stream into a digital pulse code modulated (PCM) signal. The PCM signal is further processed digitally by channel signal processing circuitry 90 to perform typical cell phone functions such as echo cancellation, frame synchronization, channel/frequency balancing, etc., before reaching the listener through the DAC 66, anti-aliasing filter 68 and the speaker 60 and/or earphones 62.

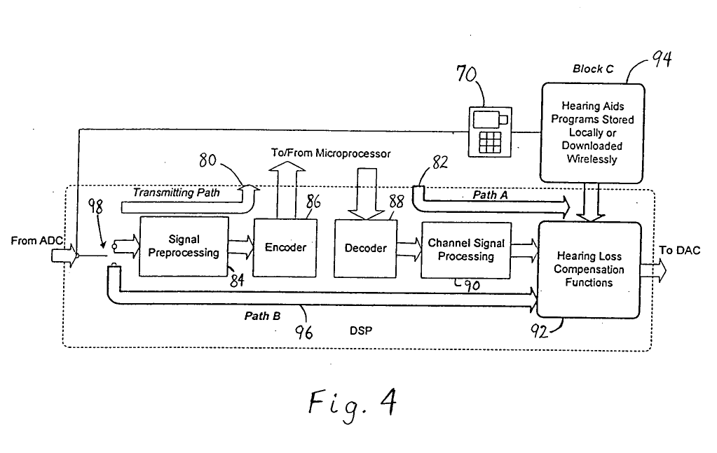

In a first embodiment of the present invention, as shown in FIG. 4, digital signal processing (DSP) algorithms or functions 92 designed to compensate for the hearing loss of a particular individual are implemented (e.g., via hardware and/or software) in addition to typical signal processing performed by the speech signal processing circuitry 90 of a digital cell phone 50. An example of a hearing loss compensating circuit or algorithm is the multi-channel compression circuit shown in FIG. 2. It is well-known that digital circuits can also be implemented as software or firmware. Therefore, the circuit of FIG. 2 may be represented as an algorithm implemented in software or firmware. For example, if implemented as software or firmware, a hearing loss compensation program can be stored in the memory 56, for example, from where it can be accessed and executed by the microprocessor 54 or DSP 52. As used herein, the term “module” refers to circuitry, software and associated hardware, firmware and associated hardware, or any combination of these implementations. Additionally, the term “program” encompasses both software and firmware in accordance with the plain and ordinary meaning of these terms to those of ordinary skill in the art. It is further understood that if the hearing loss compensation module is implemented as a program executed by the microprocessor 54, for example, appropriate data paths are provided so that sound data may be properly routed to the microprocessor 54 for hearing loss compensation processing and thereafter received by the DAC 66. Those of ordinary skill in the art can easily design such data paths and/or appropriately control, via the microprocessor 54, the DSP 52 and other components (e.g., DAC 66) within the cell phone 50 in order to route signals as necessary within the cell phone 50 electronics, without undue experimentation. Various circuit architectures and designs, which are encompassed by the present invention, may be implemented to perform the functions described herein.

In one embodiment, the hearing loss compensation circuitry shown in FIG. 2 is integrated with the conventional digital signal processing circuitry 52 and/or channel signal processing circuitry 90 of the digital cell phone 50. Alternatively, the hearing loss compensation circuit of FIG. 2 may be implemented as a separate integrated circuit chip that is coupled to the output of the channel signal processing circuitry 90 to perform hearing loss compensation functions on digital signals received from the channel signal processing circuit 90. Thus, in one embodiment, digital signals received from the channel signal processing circuit 90 are input into a digital filter bank 32 and then processed by the remaining components/circuitry 34-44 as shown in FIG. 2. Thereafter, the processed and hearing loss compensated digital signals are sent to the DAC 66 and the speaker 60 in the digital cell phone 50 in a first output mode of operation or transmitted to earphones 62 through wired or digital wireless (e.g., Bluetooth, ultra wideband, or infrared) connections in a second output mode of operation. It is appreciated that appropriate switching circuitry and/or user interface protocols (e.g., a push button or display screen menu option) that enable switching between the first and second output modes, and additional modes if desired, are easily implemented by those of ordinary skill in the art, without undue experimentation. Additionally, circuitry within the digital cell phone 50 can automatically detect the presence of the earphones 62, whether coupled via direct connection to an input port (not shown) on the cell phone 50 or via wireless coupling, and thereafter divert processed signals to the earphones 62 instead of the speaker 60. Such circuitry is well known in the art and easily implemented by those of ordinary skill in the art.

Thus, with the present invention, if a hearing-impaired user is not wearing ear phones while making or receiving a wireless call, the digital cell phone 50 may be switched to operate in a first output mode wherein the built-in speaker 60 of the digital cell phone 50 provides the hearing loss compensated sound directly to the user. Alternatively, if the user is wearing ear phones 62, the digital cell phone 50 may be switched to operate in a second output mode wherein the processed and hearing impaired compensated signal is transmitted to the ear phones 62 via wired or wireless connections (e.g., Bluetooth or infrared). In this latter embodiment, the ear phones 62 need not possess all the processing circuitry contained in conventional digital hearing aids because, this processing is handled within the digital cell phone 50. They can be off-the-shelf earphones when connected to the cell phone by wires. When digital wireless connection is used, the digital cell phone can include a short range RF transmitter (not shown), coupled to the output of the DSP 52, DAC 66, or anti-aliasing filter 68, for transmitting digital or analog signals to the ear phones 62. If the signal is transmitting in a digital format, for example, the ear phones 62 of the present invention can include a receiver for receiving short range wireless signals (e.g., Bluetooth, ultra wide band, infrared, etc.) signals, a DAC converter and an anti-aliasing filter for converting digital signals into analog signals, and a speaker for producing audible sound waves based on the received signals. In these latter embodiments, the ear phones may be part of a headset that includes the ear phones and a headset microphone for receiving speech sound waves from the user. The headset may be wired or wirelessly connected to the cell phone 50 using known techniques. If wirelessly connected, the headset microphone also includes a short range wireless transmitter for transmitting short range wireless signals to a short range wireless transceiver (not shown) within the cell phone 50.

In an additional embodiment, multiple DSP programs 94 designed to fit the needs of a hearing impaired individual in different listening environments are stored in the memory 56 of the digital cell phone 50 and their use are controlled by the user by a touch-screen display and/or keypad 70 provided on the digital cell phone 50. In a further embodiment, one or more of the multiple programs 94 may be manually or automatically selected based on the environment the user is in. For automatic selection, the user can simply select an “auto” mode wherein the microphone of the digital cell phone will “sense” the audio environment. The microphone receives ambient sound waves from the environment, converts the sound waves into an analog signal, and then transmits the analog signal to the ADC 64. The resulting digital signals generated by the ADC 64 are then sent to appropriate circuitry (e.g., microprocessor 54 or DSP 52) within the digital cell phone 50 for processing and analysis. For example, if the microprocessor 54 processes and analyzes the digital signal, the microprocessor 54 can direct the DSP 52 to pass the signal directly to the microprocessor 54 without preprocessing or encoding. In one embodiment, based on the frequency distributions of the received signals, the microprocessor 54 can execute a program that can automatically select the most appropriate hearing compensation program or algorithm 94 for the “sensed” environment. Such automatic analysis and selection programs/algorithms are known in the art and various programs/algorithms in accordance with the present invention can be implemented by those of skill in the art, without undue experimentation.

The addition of hearing loss compensation algorithms 94 in the receiving path 82 of the cell phone 50, as shown in Path A of FIG. 4, enables a hearing impaired individual to make a wireless call without the use of hearing aids. This bypasses the distortions introduced by the hearing aid transducers and room noise picked up by a separate hearing aid microphone. In addition, the problem of electromagnetic interference in a hearing aid when a cell phone is held near the hearing aid is circumvented.

In a second embodiment of the present invention, a loop back signal path 96 (Path B) is added from the microphone 58 of the digital cell phone 50 to the hearing loss compensation circuit 92. This added loop back path 96 enables ambient sound from a person speaking directly to the user to be picked up by the microphone 58 of the digital cell phone 50, converted to digital data by the ADC 64, processed for hearing loss by the hearing loss compensation circuitry 92 within the phone, and then delivered to the speaker 60 or earphones 62 of the user via wired or wireless connection, as described above. With this loop back path 96, the cell phone 50 can function as a stand alone hearing aid at the user's choice while not making a call, although the cell phone 50 could continuously monitor a pilot signal from a base station and notify the user of an incoming call. This additional functionality enables the cell phone 50 to become a wireless communication device and a stand alone hearing aid at the same time. A switch 98 allows manual or automatic selection of operating mode of the cell phone 50 as a hearing loss compensated wireless communication device or a stand alone hearing aid. As a result, the hearing impaired user of the cell phone would not need additional hearing aids either on-line (making a call) or off-line (not making a call).

In a third embodiment of the present invention, the data link capabilities of digital cell phones are used to download additional signal processing programs 94 that are not available on the phone to meet the various needs of a hearing impaired individual at different listening environments. For example, noise has many different forms: road noise, cafeteria noise, babble noise, etc, and each has its own acoustic characteristics. It is often difficult to predict the noise environment and the signal processing needs of a hearing impaired individual.

In one embodiment, a wireless data service can be used to download the proper signal processing algorithms to compensate for hearing loss, as described in the previous embodiment, either at the choice of the user or as the result of an analysis on the sound signals received by the cell phone when it is in the hearing aid mode. Thus, the manual or automatic selection of hearing-aid processing programs based on the environment of the user provides an adaptive method of selecting signal processing algorithms from a practically unlimited source (e.g., an online database) because of the network connection capabilities of the digital cell phone. In contrast, contemporary hearing aids only have a small set of signal processing algorithms available and functional adaptation to the environment is not feasible. In one embodiment, if a desired hearing loss compensation program is not stored in a memory of the digital cell phone, the hearing loss compensation circuitry or program 92 sends a request to the microprocessor 54 to download the desired program from an external source (e.g., a database) via wireless Internet access protocols, well known in the art.

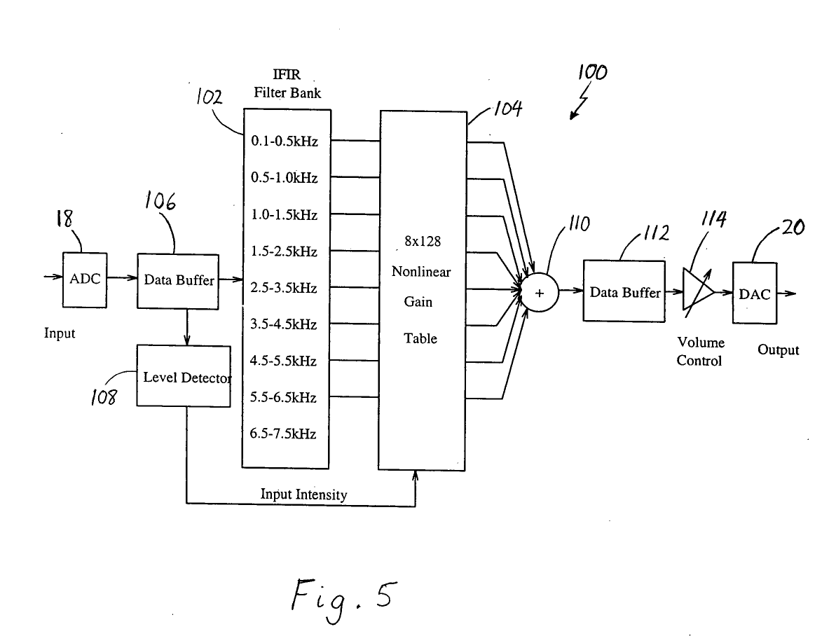

FIG. 5 illustrates a second exemplary hearing loss compensation circuit or module 100, in accordance with one embodiment of the invention. One function of hearing aids is to amplify an incoming speech signal at frequencies where hearing loss is prominent. Because of the reduced dynamic range of hearing in an impaired ear, in order to hear all sounds comfortably, non-linear amplification is utilized to map (squeeze) a wide range of speech signals into the reduced range of hearing in an impaired ear. In accordance with one embodiment of the invention, the hearing compensation circuit 100 provides level-dependent gains at frequencies where hearing loss is prominent. Low level sounds are amplified with relatively small dynamic range compression whereas high level sounds are amplified with relatively large dynamic range compression. Thus, the compensation circuit 100 provides a frequency- and level-dependent amplification function or algorithm for processing data.

As shown in FIG. 5, the compensation circuit 100 includes an interpolated finite impulse response (IFIR) filter bank 102. The filter bank 102 provides frequency separation for an incoming digital signal so that different levels of amplification can be applied at different frequency ranges (like an equalizer). In one embodiment, each filter in the filter bank 102 possesses an adequate amount of stop-band attenuation. Additionally, each filter should exhibit a small time-delay (e.g., <8 msec) so that it does not interfere with normal speech production and perception. As is known in the art, achieving adequate stop-band attenuation and a small time-delay are competing goals that require design compromises.

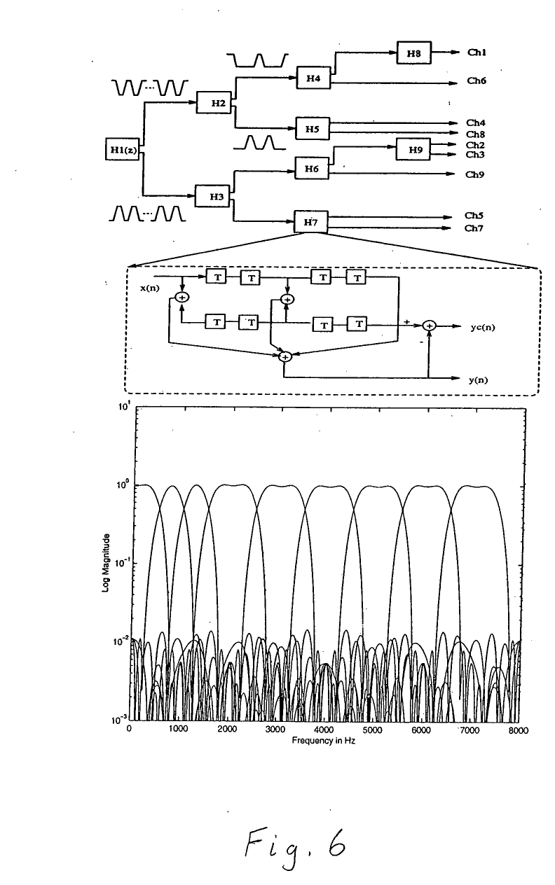

One effective solution is to use a hierarchical, interpolated finite impulse response (IFIR) filter bank 102. One embodiment of a filter structure and its frequency response are shown in FIG. 6. In this embodiment, the filter bank 102 has 9 channels, covering the frequency range of 0-8 kHz. The channel attenuation of each filter is about 35-40 dB. The channel bandwidth is about 250 Hz for the 3 low frequency channels, and about 1000 Hz for the high frequency channels. In one embodiment, narrower bandwidth is used at low frequencies because of a higher frequency resolution of the human auditory system. Computationally, in one embodiment, the filter bank 102 has about 68 non-zero coefficients and about 200 zero-valued coefficients. This means that a total of 68 multiplications are performed on each sample of input signal when utilizing the entire filter bank. In this embodiment, the delay of the system can be as small as 77 samples (4.8 msec when the signal is sampled at 16 kHz). In one embodiment, eight out of the nine channels are used to produce the amplified speech output and the highest frequency channel is dropped for anti-aliasing purposes.

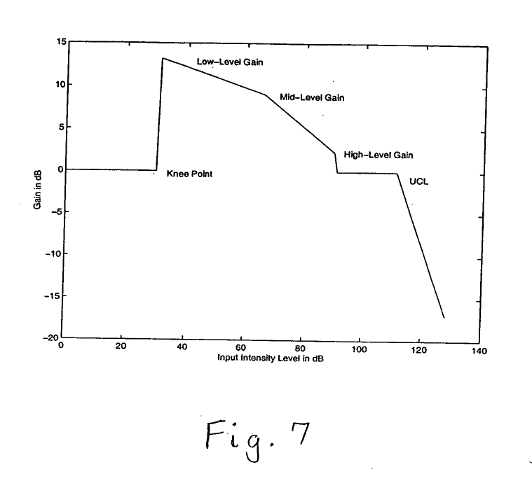

The outputs of the filter bank 102 serve as the inputs to a nonlinear gain table or compression module 104. The compression module 104 is a level-dependent gain table for non-linear amplification. It has 8×128 (channel×input level) entries, limiting the input intensity to the range of 0-128 dB. After an analog signal representative of sound waves has been converted into digital data by the ADC 18, the data is stored in a data buffer 106. An input level is computed by a level detector 108 coupled to the data buffer 106 as the average intensity in dB within a small time window (for example, 128 points or 8 msec when the signal is sampled at 16 kHz). The gain level of each frequency channel, otherwise referred to as a gain table entry, is computed as a piece-wise linear function of the input level calculated by the level detector 108. An exemplary piece-wise linear gain function is shown in FIG. 7. However, many different gain functions can be utilized for each frequency channel in order to achieve various types of hearing loss compensation.

The outputs of the nonlinear gain table or compression module 104 are added together by a summer circuit 110, temporarily stored in a second data buffer 112, and then output as the final amplified speech signal. In one embodiment, a volume control circuit 114 is provided to allow a user to interactively adjust the overall level of the signal provided to the DAC 20 and ultimately provided to a hearing impaired user.

In one embodiment, the activation of the compression module 104 function is controlled by a user through the keypad/display 70 (FIG. 3A). Once the non-linear amplification is activated, the received and decoded digital PCM (speech) signals are filtered and amplified based on the selected nonlinear amplification algorithms. The amplified PCM signal will be sent to the user through the digital-to-analog converter (DAC) 20 and the speaker 60 and/or earphones 62.

In a further embodiment, to enable the non-linear amplification during standby mode, a menu item or icon is provided on the display 70 for selection by a user of the cell phone. Once selected, the cell phone 50 will function as an off-line hearing aid, where the microprocessor 54 only monitors a pilot signal from a base station and notifies the user of any incoming call. All other functions of the digital cell phone 50 are disabled. In standby mode, the audio signal from the microphone 58 on the cell phone 50 is sent directly to the hearing loss compensation module, rather than the encoder 86 of the DSP 52. The hearing loss compensation module 92 processes the re-directed signal using a user selected, non-linear amplification algorithm. The processed signal is delivered back to the user through the DAC 20 and speaker 60 or earphones 62. In a further embodiment, a stereo earphone is provided for binaural hearing loss.

In summary, the embodiments of this invention present methods for enabling hearing aid functions on digital cell phones. With a hearing-aid enabled cell phone, people with hearing loss can enjoy wireless communication using a single device or system. In addition, the cell phone can be used as a stand alone hearing aid so that the hearing impaired user of the cell phone does not need to carry separate specialized hearing aids. The cell phone has the computing resources and wireless connection that permit advanced signal processing methods to be implemented for hearing loss compensation that are not feasible on contemporary hearing aids. There has not been a device available that supports both hearing-aid and cell-phone functions. Thus, the hearing aid enabled cell phone system of the present invention provides a useful device to millions of individuals with sensory hearing loss.

As described above, the invention provides a novel method and system for providing hearing aid functions via a digital cell phone. One of ordinary skill in the art will appreciate that the above descriptions of the preferred embodiments are exemplary only and that the invention may be practiced with modifications or variations of the techniques disclosed above. Those of ordinary skill in the art will know, or be able to ascertain using no more than routine experimentation, many equivalents to the specific embodiments of the invention described herein. Such modifications, variations and equivalents are contemplated to be within the spirit and scope of the present invention as set forth in the claims below.

1. A digital cell phone having hearing aid functionality, comprising:
a microprocessor;
a memory, coupled to the microprocessor, for storing at least one program executable by the microprocessor;
a key pad, coupled to the microprocessor, for entering alphanumeric information to be processed by the microprocessor;
a display screen, coupled to the microprocessor, for displaying alphanumeric information received from the microprocessor;
a radio frequency (RF) antenna, coupled to the microprocessor, for transmitting and receiving RF signals;
a microphone for receiving sound waves and converting the sound waves into an analog signal;
an analog-to-digital converter (ADC), coupled to the microphone, for converting the analog signal received from the microphone into a digital data format;
a digital signal processor (DSP) comprising an encoder for encoding digital data into an RF signal format to be transmitted by the RF antenna and a decoder for decoding digital data received by the RF antenna;
a hearing loss compensation module, coupled to the DSP, for processing digital data in accordance with a hearing loss compensation algorithm;
a digital-to-analog converter (DAC), coupled to the hearing loss compensation module, for converting the processed digital data received from the hearing loss compensation module into an analog signal; and
a speaker, coupled to the DAC, for receiving the analog signal from the DAC and outputting audible sound waves adapted for listening by a hearing impaired user.

2. The digital cell phone of claim 1 wherein the hearing loss compensation module comprises a circuit integrated with other circuitry of the DSP in a single integrated circuit chip.

3. The digital cell phone of claim 1 further comprising an interface port for coupling at least one ear phone to the DAC wherein the at least one ear phone receives the analog signal from the DAC and outputs the audible sound waves.

4. The digital cell phone of claim 1 further comprising a wireless interface for coupling at least one wireless ear phone to the output of the hearing loss compensation module, wherein the wireless interface comprises a transmitter for transmitting short range wireless signals and the at least one wireless ear phone comprises a receiver for receiving the short range wireless signals.

5. The digital cell phone of claim 4 wherein the at least one wireless ear phone further comprises a second digital-to-analog converter (DAC) for converting received digital data into an analog signal, and a mini-speaker for converting the analog signal from the second DAC into audible sound waves.

6. The digital cell phone of claim 1 wherein the cell phone provides at least two signal processing paths, a first signal processing path being utilized when the cell phone is operating as a digital cell phone wherein audio data received by the RF antenna is processed by the hearing loss compensation module, and a second signal processing path being utilized when the cell phone is operating as a standalone hearing aid device and sound waves received by the microphone are converted into a digital data format and thereafter processed by the hearing loss compensation module.

7. The digital cell phone of claim 1 wherein the hearing loss compensation module comprises processing circuitry for executing a hearing loss compensation program stored in the memory.

8. The digital cell phone of claim 7 wherein a plurality of hearing loss compensation programs are stored in the memory, each of the hearing loss compensation programs being user selectable and comprising a unique hearing loss compensation algorithm.

9. The digital cell phone of claim 8 further comprising an automatic selection program stored in the memory that when executed measures ambient noise characteristics of an environment and thereafter automatically identifies one of a plurality of hearing loss compensation programs that is best suited for that particular environment based on the ambient noise measurements.

10. The digital cell phone of claim 9 wherein if the identified hearing loss compensation program is not stored in the memory, the automatic selection program sends a request to the microprocessor to download the identified hearing loss compensation program from an external source and store the selected program in the memory.

11. The digital cell phone of claim 7 wherein the hearing loss compensation program is downloaded from an external source and stored in the memory.

12. A hearing loss compensating communication system, comprising:
a digital cell phone for transmitting and receiving voice data, wherein the digital cell phone comprises circuitry for converting sound waves into a digital data format for transmission and converting received voice data into audible sound waves; and
a hearing loss compensation module, coupled to the circuitry, for further processing the received voice data in accordance with a hearing loss compensation algorithm, wherein the processed voice data when converted into an analog format provides enhanced sound waves adapted for listening by a hearing impaired listener.

13. The hearing loss compensating communication system of claim 12 wherein the circuitry within the digital cell phone comprises:
a microphone for receiving sound waves and producing an analog signal representative of the sound waves;
an analog to digital converter (ADC), coupled to the microphone, for converting the analog signal into digital data; and
a processing path that enables the digital cell phone to function as a standalone hearing aid device wherein digital data output from the ADC is delivered to the hearing loss compensation module for processing in accordance with the hearing loss compensation algorithm.

14. The hearing loss compensating communication system of claim 12 further comprising an ear phone coupled to the digital cell phone for providing the enhanced sound waves to the hearing impaired listener.

15. The hearing loss compensating communication system of claim 14 further comprising a digital-to-analog converter (DAC), coupled to an output of the hearing loss compensation module, for converting the processed digital data into an analog signal, wherein the ear phone is coupled to an output of the DAC for receiving the analog signal and converting the analog signal into audible sound waves.

16. The hearing loss compensating communication system of claim 14 wherein the ear phone is wirelessly coupled to the digital cell phone, the ear phone comprising a receiver for receiving electromagnetic signals from the digital cell phone.

17. The hearing loss compensating communication system of claim 12 wherein the hearing loss compensation module comprises processing circuitry for executing a hearing loss compensation program stored in a memory of the digital cell phone.

18. The hearing loss compensating communication system of claim 17 wherein a plurality of hearing loss compensation programs are stored in the memory, each of the hearing loss compensation programs being user selectable and comprising a unique hearing loss compensation algorithm.

19. The hearing loss compensating communication system of claim 18 further comprising an automatic selection program stored in the memory that when executed measures ambient noise characteristics of an environment and thereafter automatically identifies one of a plurality of hearing loss compensation programs that is best suited for that particular environment.

20. The hearing loss compensating communication system of claim 19 wherein if the identified hearing loss compensation program is not stored in the memory, the automatic selection program sends a request to the microprocessor to download the identified hearing loss compensation program via a wireless communication link and store the selected program in the memory.

21. The hearing loss compensating communication system of claim 17 wherein the hearing loss compensation program is downloaded from an external source and stored in the memory.

22. A digital cell phone with built in hearing aid functionality, comprising:
a housing;
a digital signal processor (DSP) contained within the housing for encoding and decoding digital data;
a hearing loss compensation module, coupled to the DSP, for processing digital data in accordance with a hearing loss compensation algorithm;
a digital-to-analog converter (DAC), coupled to the hearing loss compensation module, for receiving the processed digital data from the hearing loss compensation circuit and converting the data into an analog signal; and
a speaker, coupled to the DAC, for receiving the analog signal and converting the analog signal into sound waves adapted for a hearing impaired listener.

23. The digital cell phone of claim 22 wherein the hearing loss compensation module comprises a circuit integrated with other circuitry of the DSP in a single integrated circuit chip.

24. The digital cell phone of claim 22 further comprising an interface port for coupling at least one ear phone to the DAC wherein the at least one ear phone receives the analog signal from the DAC and outputs hearing loss compensated audible sound waves.

25. The digital cell phone of claim 22 further comprising a wireless interface for coupling at least one wireless ear phone to the output of the hearing loss compensation circuit, wherein the wireless interface comprises a transmitter for transmitting short range wireless signals.

26. The digital cell phone of claim 25 wherein the at least one wireless ear phone comprises a receiver for receiving short range wireless signals, a second digital-to-analog converter (DAC) for converting received digital data into an analog signal, and a mini-speaker for receiving the analog signal from the second DAC and producing audible sound waves.

27. The digital cell phone of claim 22 wherein the cell phone provides at least two signal processing paths, a first signal processing path being utilized when the cell phone is operating as a digital cell phone wherein audio data received in a RF data format via the RF antenna is processed by the hearing loss compensation module, and a second signal processing path being utilized when the cell phone is operating as a standalone hearing aid device wherein analog signals received via the microphone are converted into a digital data format and thereafter processed by the hearing loss compensation module.

28. The digital cell phone of claim 22 wherein the hearing loss compensation module comprises processing circuitry for executing a hearing loss compensation program stored in a memory of the digital cell phone.

29. The digital cell phone of claim 28 wherein a plurality of hearing loss compensation programs are stored in the memory, each of the hearing loss compensation programs being user selectable and providing a unique hearing loss compensation function.

30. The digital cell phone of claim 29 further comprising an automatic selection program stored in the memory that when executed measures ambient noise characteristics of an environment and thereafter automatically identifies one of a plurality of hearing loss compensation programs that is best suited for that particular environment.

31. The digital cell phone of claim 30 wherein if the identified hearing loss compensation program is not stored in the memory, the automatic selection program initiates a download routine wherein the identified hearing loss compensation program is downloaded from an external source and stored in the memory.

32. The digital cell phone of claim 28 wherein the hearing loss compensation program is downloaded from an external source and stored in the memory.

33. A method of compensating for hearing loss using a digital telephone, comprising:
receiving a digital signal via a digital phone;
decoding the digital signal so as to provide a second digital signal in a predefined format;
processing the second digital signal in accordance with a hearing loss compensation algorithm so as to provide a hearing loss compensated digital signal;
converting the hearing loss compensated digital signal into an analog signal; and
converting the analog signal into audible sound waves adapted for a hearing impaired listener.

34. The method of claim 33 wherein the predefined format comprises a pulse code modulation (PCM) format.

35. The method of claim 33 wherein the act of processing the second digital signal comprises executing a hearing loss compensation program stored in a memory of the digital telephone.

36. The method of claim 35 wherein the hearing loss compensation program is downloaded by the digital telephone from an external source and stored in the memory.

37. The method of claim 35 further comprising storing a plurality of hearing loss compensation programs in the memory, each hearing loss compensation program providing a unique hearing loss compensation function.

38. The method of claim 37 further comprising:
measuring ambient noise parameters; and
identifying a hearing loss compensation program from the plurality of program that is best suited to compensate for hearing loss based on the measured ambient noise parameters.

39. The method of claim 38 further comprising automatically executing the identified hearing loss compensation program.

40. The method of claim 33 further comprising providing the audible sound waves via an ear phone coupled to the digital telephone.

41. The method of claim 40 wherein the ear phone is wirelessly coupled to the digital telephone.
